(19) United States
(12) Patent Application Publication
(10) Pub. No.: US 2019/0303850 A1
(43) Pub. Date: Oct. 3, 2019

(54) Nonintrusive, Sensor-Driven Processor for Managing Stored Commodities

(71) Applicant: Stockscan, Zug (CH)

(72) Inventors: Christopher Paul Mangos, Oberaegeri (CH); Svetozar Putincanin, Zug (CH); Markus Hans Gross, Zurich (CH); David Alan Basin, Rueschlikon (CH); Gregory David James, Tokai (ZA)

(21) Appl. No.: 16/442,370

(22) Filed: Jun. 14, 2019

Related U.S. Application Data
(63) Continuation-in-part of application No. PCT/CH2017/050008, filed on Dec. 14, 2017.
(60) Provisional application No. 62/434,231, filed on Dec. 14, 2016.

(51) Int. Cl. G06Q 10/08; G01D 9/00

(52) U.S. Cl. CPC G06Q 10/087; G01D 9/00

(57) ABSTRACT

A computer system monitors physical commodities based on sensor data about those physical commodities using a virtual vault to define a space. The computer system comprises a plurality of sensors, spatially positioned to cover a predefined delineated space containing an inventory of the physical commodities and includes a processor, coupled to receive signals from the plurality of sensors, and a memory that provides storage for sensor data. The processor can execute programming code stored in nontransitory computer readable media that includes program code for calculating a plurality of physical properties of the inventory, program code for determining one or more boundaries of the predefined delineated space, program code for mapping changes in the sensor data to changes in the physical properties of the inventory, and program code for determining a response to changes in an inventory that are based on the changes in the physical properties of the inventory.

### CROSS-REFERENCES TO PRIORITY AND RELATED APPLICATIONS

This application is a continuation of PCT Application No. PCT/CH2017/050008, filed on Dec. 14, 2017, entitled “ NONINTRUSIVE, SENSOR-DRIVEN PROCESSOR FOR MANAGING STORED COMMODITIES,” which claims the benefit of U.S. Provisional Patent Application No. 62/434,231, filed Dec. 14, 2016, entitled “NONINTRUSIVE, SENSOR-DRIVEN PROCESSOR FOR MANAGING STORED COMMODITIES.” The entire disclosure of the application recited above is hereby incorporated by reference herein in its entirety, as if set forth in full in this document, for all purposes.

### FIELD OF THE INVENTION

The present disclosure generally relates to computerized, nonintrusive, sensor-driven systems for managing stored commodities. The disclosure relates more particularly to apparatus and techniques for tracking, inventorying and monitoring commodities and other goods stored in a monitored location with no, or reduced, human interaction requiring little or no technical dependencies on existing infrastructure of the monitored location.

### BACKGROUND

Tracking inventory of commodities is useful in a variety of situations. For example, a company might want to have updated information about what is present in their warehouse. As another example, a lender having a secured interest in inventory of commodities might want to be alerted when the inventory changes or if it changes according to a predefined schedule. As another example, a consignor might want to track their inventory that is held by a consignee.

One method of tracking inventory is to have a person or team of people visit the location where the inventory is stored and count the inventory. This is often impractical and costly so that such inventorying is only done infrequently. Another method is to attach some computer readable and electronically communicating device to each item in the inventory. This may work for certain inventory items, but in other cases, that is also impractical and/or too costly. For example, where the inventory comprises various different kinds of rock that are stored in piles, it would be impractical to apply an RFID tag that accurately indicated the amount of rock in a given pile. Even in the case of an inventory comprising countable units, the process of using RFID tags to mark each item depends on human interaction and therefore might not be as reliable as an automated process, especially where the person assigned to apply or mark each item is not an interested party with respect to those goods to be inventoried. Furthermore, the misuse of tags or their removal or destruction might not be efficiently controlled or audited. Owners of inventory items might therefore not be provided with fully accurate status information.

What is needed is an improved method and apparatus for determining an inventory without the need for manual counting or specialized environments

### SUMMARY

A computer system monitors physical commodities based on sensor data about those physical commodities using a virtual vault to define a space. The computer system comprises a plurality of sensors, spatially positioned to cover a predefined delineated space containing an inventory of the physical commodities and includes a processor, coupled to receive signals from the plurality of sensors, and a memory, coupled to the processor, that provides storage for sensor data. The processor can execute programming code stored in nontransitory computer readable media that includes program code for calculating a plurality of physical properties of the inventory, program code for determining one or more boundaries of the predefined delineated space, program code for mapping changes in the sensor data to changes in the physical properties of the inventory, and program code for determining a response to changes in an inventory that are based on the changes in the physical properties of the inventory.

The computer system may further comprise a plurality of servers capable of communicating with the processor over a network, thereby providing resilience against errors and an independent path from the plurality of sensors to the processor, program code for recording objects of interest passing through the boundaries of a predefined delineated space, program code for issuing alarms based on a further analysis of determined changes to the inventory level, storage for archiving services, transactions occurring with respect to the boundaries, and data related to object recognition and machine learning, and program code for analyzing archived data to derive historical data used by the program code for determining a response to provide improved responses.

The computer system might also include a plurality of cryptographic processors that use digital signatures, message authentication codes, encryption, and standard Internet security protocols, program code for implementing heartbeat messages, timestamps, and counters, and program code for access control to restrict access to sensor data, logs, and other collected or processed data on the processor and the plurality of servers. The sensors might comprise optical devices, cameras, light detectors, lasers, depth sensors, motion sensors, radar, weight sensors, pressure sensors, and/or ultrasonic emitters. The physical properties of the inventory might comprise volume, shape, weight, material, number of units, and/or density. The boundary of the predefined delineated space might correspond to a building interior, a silo, a bunker, or a bounded outdoor space.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 illustrates an example monitoring and tracking system.

FIG. 2 illustrates an object moving across a boundary of a virtual vault.

FIG. 3 illustrates an example of a set of time periods for a schedule.

FIG. 4 illustrates another example of a set of time periods.

FIG. 5 illustrates an example of scheduled movements.

FIG. 6 illustrates an example of alerts for minimum limits.

FIG. 7 illustrates a reconciliation process.

FIG. 8 illustrates an example movement report

FIG. 9A illustrates a snapshot of a sequence of reports.

FIG. 9B illustrates a second snapshot of a sequence of reports.

FIG. 9C illustrates a third snapshot of a sequence of reports.

FIG. 10 is a block diagram that illustrates a computer system upon which an embodiment of the invention may be implemented.

FIG. 11 illustrates two point cloud volumes outlining two rolls of commodity metal.

FIG. 12 is a flow chart of a method for estimating a weight of commodities from sensor input.

FIG. 13 is a flow chart of a method of calculating inventory from deltas of objects entering and exiting a virtual vault or other region.

FIG. 14 is a flow chart of a method of calculating inventory of a virtual vault or other region.

FIG. 15 is a flow chart of a method of detecting if changes in inventory are in accordance with a schedule.

FIG. 16 illustrates an example flow of data from the sensors through the monitoring and tracking system.

FIG. 17 illustrates the fraction of work that is manually done in the service center as a model is trained.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described and suggested herein might be used with many different types of inventory. For example, an inventory might include steel hot rolled coils, steel slabs, steel reinforcement bars (rebar), copper cathodes, copper billets, copper bars, coils/slabs/bars, etc. of copper, iron, tungsten, aluminum, etc. An inventory might include more than one of these, and possibly unrelated materials of different forms. The inventory might be scrap metal, unrefined ore in piles or other structures, ingots, T-bars or other forms. The inventory might include coffee sacks, cocoa sacks, coal, wood pulp, wood boards, sacks of grain, loose grain, material that is packaged or unpackaged, etc. The inventory might also include liquids and/or gasses. The inventory might be raw materials or finished goods.

Inventory on consignment or secured assets present particular issues, as the custody of the inventory is a party other than one that might have the most financial interest in having a correct inventorying of the commodities.

The need to manage cargoes in a supply chain is centuries old. Typically the processes have had to be done manually, such as by relying on people to perform the tasks of moving, counting and reporting on cargoes stored in warehouses, factories, ships, trucks and rail. While the personnel performing these tasks can be closely monitored and supervised by their immediate employer, often that immediate employer does not have the primary risk of loss on the inventory, but is merely the custodian of the inventory for a consignor. As a result, it might be harder for that custodian company to control and prevent fraudulent activities perpetuated by employees of the custodians of the cargoes as a result of negligence, bribery and/or coercion.

Automating the determination of what is present in an inventory, i.e., inventorying that inventory, can be a difficult task. Sometimes, an inventory owner will rely on placing their own dedicated staff to observe and log inflows and outflows, but this still might not provide updated inventory information. Using systems described herein, an inventory owner can arrange to receive alerts should any inventory fall out of criteria set by the inventory owner, such as detecting an unscheduled outflow of inventory or a change in an inventory level as detected by processing sensor data of the inventory. For example, in a monitoring system described herein, a plurality of cameras is provided that captures sensor data of inventory, such as aluminum bars stacked on pallets, from different angles. The monitoring system compiles these images into a three-dimensional representation of a space enclosing the inventory. The monitoring system can deal with irregular or partial pallets, so as to be able to determine a total number of units in a location, even though individual pallets may not contain the same number of units. In the case of commodity metal, if different bars had different dimensions of, for example, aluminum, the system could calculate the total number of tons of aluminum comprising those bars.

The monitoring system can deal with varying items, such as coils of metal sheets that might have different coil thicknesses due to coils varying in the length of metal sheet in each coil and/or differences in the inner diameter of the coil (the gap in the center of the coil).

The space enclosing the inventory might by a physically constrained space, such as a warehouse having only two doors, which are monitored. The space might be a logical space, such as a logical partition of a warehouse for different owners' goods, separated by a walking area, but not necessarily a physical barrier or boundary.

For cost-effectiveness and security, sensors are deployed at the site of the inventory and report, more or less, raw sensor data to a central, cloud-based processing system. In this manner, the data generated by the plurality of sensors might not need to be secured as they would be reporting information that the warehouse owner or other space owner can measure themselves. However, the data is preferably secured against unauthorized tampering.

With the processing of the raw sensor data being done off-site, often in jurisdictions with suitable data privacy regimes, the interested party (the inventory owner, the secured lender, etc.) can control who has access to the processed data about the inventory. For example, an exact calculation, week by week, of a company's inventory of raw materials may signal the company's production rates and variations might leak business trade secrets. Thus, it is desirable to have such computations done more under the control of the company rather than their warehousers.

In an example implementation described in more detail herein, a monitoring system is programmed to receive, passively or by querying, sensor data relevant to a particular inventory space. Using sensor data provided by a variety of sensors, such as weight sensors, image capture devices, depth sensors, etc., the monitoring system processes that sensor data to determine the types and quantities of various physical commodities in the inventory space. From that sensor data, the monitoring system can populate databases of inventoried items as needed and provide messages in the form of alerts, alarms, etc. to signal conditions. The monitoring system might include backend reporting and alerting services, program code for coil monitoring algorithms, optical character recognition (OCR) processes, etc. and include storage for event tables (audit trails of inflows and outflows and absolute inventory measurements, for example), databases, report generators, an inventory delta manager and associated alerts and invoicing modules. This allows for storage of data for object recognition in the world of commodities and provides information about what commodity is stored where, in near real-time.

The monitoring system can deal with solid objects, unitized objects (e.g., steel coils, perhaps with each unitized object being marked with identifying marks, such as nominal weight, product description, etc.), bulk stock (e.g., loose grain, bulk wood pulp, coal, scrap metal of irregular sizes, and other materials stored in stockpiles, silos and bunkers where identifying each individual unit is not required), but also liquids and gasses, stored in tanks and volumes normally measured by flow meters (e.g., diesel).

Unlike a house or an apartment, commodities are mobile and can be removed without a lender's permission when stored in a consignment stock. Banks face ever stricter rules for determining genuine “collateral” and proving that the collateral still exists and for showing that the storage arrangement satisfies “prudence” requirements of the cargo insurers (which represent the “exit” for a bank in the event of loss, theft or damage to the cargoes).

To satisfy the prudence and genuine collateral criteria banks turn to independent parties who “watch over” the inventory. This can be done by warehouse agreements, collateral management agreements (CMAs), and/or inventory monitoring.

With a warehouse agreement, a warehouse company provides a complete storage, handling and administration infrastructure to a party wishing to store cargoes in transit. The land and buildings are either leased or owned by the warehouse company. They have their own people and equipment to discharge and load vehicles (ships, barges, rail and road), they have their own equipment for weighing the cargoes and their administration provides a wide range of services from VAT and Customs administration to providing transportation documentation. In such cases, warehouse operator is fully liable for errors and fraud committed by their own personnel and this can be good for the owner of the goods, but it is expensive. For example, more than ten percent of the value of a rotating stock of raw materials might be consumed each year by this warehousing process.

With CMAs, a debtor, a creditor and a Collateral Manager (CM) might have a tripartite agreement setting out, inter alia, the obligations of the Collateral Manager, an independent third party. Theoretically this person (or persons) monitors the movements of the cargoes in and out of the CMA storage space and physically intervenes when a condition of the CMA is breached. The CMA arrangement might cost a few percent of the total cost of the inventory.

With a typical inventory monitoring service, a neutral party watches over stored cargoes and may permanently station dedicated staff at the warehouse. Alternatively, the monitoring party visits the warehouse on a periodic basis to inspect the goods stored. Reports are provided, often inclusive of photographs, if requested. This manual approach is still labor-intensive, prone to errors and abuse, and alerts are only possible when staff detects an inventory error.

With delta monitoring, inventorying is done by counting/measuring goods as they enter or exit the designated inventory space and the sum of all the movements equals the total volume. This can mimic existing manual inventory management procedures. To do this, sensors, such as cameras, can be mounted on overhead gantry doors and/or on vehicles used to move the material, such as cranes and stackers/loaders. The vehicles can be individually tracked, such as by barcoding that is visible to camera arrays.

Some of the processing done at a remote server might include processing imagery to estimate a volume of space actually occupied by the material, taking into account that there might be gaps (as with stacked cylindrical objects), irregular sizes (often needing processing to perform edge detection), and partial blocks.

In addition to two-dimensional camera taking two-dimensional video images, three-dimensional cameras might be used to perform a volumetric scan of a point cloud to create a three-dimensional representation and calculate the volume of all the goods in a space. This process may be repeated on a very frequent basis. Multiple views from traditional cameras may be combined to create the point cloud. Cameras might be combined with non-image sensors, such as radar, LiDAR, or time of flight (ToF) cameras. In some cases, the system can perform more complex point cloud processing, such as where only a partial scan is available. This might be useful for determining volume of partially filled containers.

A weight mat or other sensors for weight might be used as a sensor to provide an overall weight. Imagery might be used to estimate what proportion of the weight is the raw material and what proportion is packaging, etc.

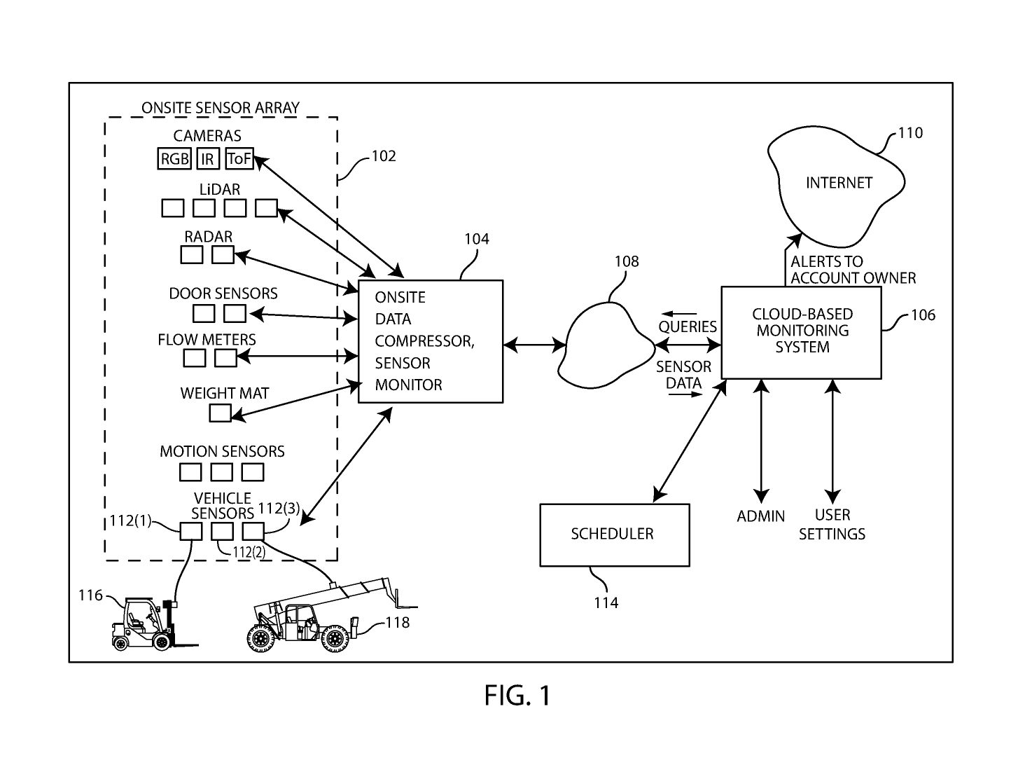

FIG. 1 illustrates an example monitoring and tracking system. As shown there, an array of sensors 102 generate sensor readings onsite at a location of an inventory of commodities or other goods in a defined space for that inventory that is physically or logically bounded. Sensors 102 may include cameras, such as RGB cameras, infrared cameras, and/or time of flight cameras. Sensors 102 may also include LiDAR and radar range finding sensors. Sensors 102 may include door sensors, flow meters, weight mats, and motion sensors. Sensors may include vehicle sensors 112(1), 112(2), and 112(3) which track vehicles 116, 118, for example by a GPS unit mounted to the vehicle. The sensors are placed such that data from combinations of sensors can be used to determine an inventory level and/or changes in inventory. Sensors in sensor array 102 communicate with an onsite data compressor and sensor monitor 104. Onsite data compressor and sensor monitor 104 compresses the sensor data received from sensors and forwards that data to a monitoring server 106, via a network 108, which might be the Internet, an intranet, a cellular connection (such as LTE), or other channel. Onsite data compressor and sensor monitor 104 also monitors sensors for failure, power loss and tampering and communicates such status to monitoring server 106. In some implementations, onsite data compressor and sensor monitor 104 has the ability to reset sensors as needed. Monitoring server 110 processes the sensor data to determine inventory levels and changes, and may send alerts over Internet 110 to client devices. The processing of sensor data might include a machine learning component that provides weight to prior measurements.

As shown, vehicle sensors 112 might be used to detect movements and activities of vehicles 116, 118 related to the inventory. A scheduler 114 may keep a schedule of planned movements, and movements outside of planned times may cause an alarm or other alert. Some components may not be present in all systems. For example, the data compression might be optional, but if used, it might include some preprocessing to reduce the amount of data transmission needed. Compression parameters might vary based on commands sent by monitoring system 106. Since each component can run without requiring human intervention, the inventory can be measured at any time.

As used herein, inventories comprise raw materials, finished materials, etc. that are commodities (which might be goods not traditionally referred to as commodities, but that nonetheless can make up an inventory) wherein some party has an interest in the commodities and thus may want accurate, up-to-date information about those commodities. The commodities might be in the custody of a party distinct from the party having an interest. This might be due to the commodities being transported through a supply chain (e.g., cargo) or due to consignment arrangements. Commodities can have defined shapes (e.g. coils, billets, ingots, bundles of ingots, bars, etc.) and can be of a defined substance (e.g. aluminum, copper, wheat, etc.)

Monitoring server 106 might comprise multiple servers in a networked arrangement and might monitor multiple inventories for unrelated parties. In effect, as to each inventory, monitoring server 106 provides a “virtual vault” to effectively protect assets by processing the sensor data, including collectively considering sensor data from different types of sensors. Computer processing at monitoring server 106 might discern specific objects, a count of those objects, as well as a delineation of the space in which those objects resides and points of entry and exit.

The managed environment provides entities depositing their goods on the premises of third parties with control over their goods. The delineated spaces where goods are stored might be locked rooms in a large building, the entire building itself, stacks along a wall or fence, stacks in an open space.

Sensors might be located on cranes, forklifts and stackers, walls, fences, floors, light towers, over doorways and from ceilings. Collectively, the sensor data is used, along with possible machine learning processes, to perform an ICM operation (I=identifying what is an object in the inventory and what is not, C=counting the items in inventory, and M=measure each unit of the goods). An ICM operation can be performed each time the movement of goods is detected, at some periodic interval, and/or specifically when an inflow or outflow is detected. Inflows and outflows refer to movements of some or all of the goods into, or out of, the delineated space for the inventory. Thus, movement entirely within the delineated space, such as moving a pallet of goods within a warehouse floor space designated for a particular inventory might not be treated as an inflow or outflow. An ICM operation might comprise a volumetric scan of the entire designated space of a given inventory to provide an “absolute value” of the inventory. The sensors might be arrayed such that the designated space forms a predefined delineated space with defined boundaries such that movement within the predefined delineated space not passing through the defined boundaries is not flagged as an event, movement outside the predefined delineated space not passing through the defined boundaries is not flagged as an event, and movement crossing the defined boundaries is flagged as an event. In examples, the predefined delineated space might be a rectangular prism enclosing warehousing space. In other examples, it is an irregular polygonal shape and in other, more general cases, it is a space enclosed by a predefined curved or noncurved surface.

From the sensor data, the monitoring system can recognize objects and material types and differentiate from surroundings, vehicles 116, 118 used for transporting the objects, etc. In some embodiments, the system may recognize individual units, in addition to recognizing what type of object the individual unit is.

The system may identify individual units by, for example, identifying unique markings on a unit, such as scratches or other irregularities on ingots or billets of metal. Generally, the exterior of an object, when examined closely enough, will have unique identifying marks and characteristics on its surface. The exteriors of objects packaged for shipping, such as ingots or billets of metals, are intended to take some abuse and will develop unique irregularities that may act as a digital fingerprint for the object, distinguishing it from other objects that are of the same type even though they might not have explicit markings indicative of a unique identity. Tradition codes such as QR codes, OCR codes, or barcodes may also be used to identify individual units.

By identifying an object's unique identifying marks, the system may track when the object enters or exits a virtual vault. This offers a less intrusive tagging system than, for example RFID. Digital fingerprinting is also more difficult to tamper with than, for example, RFIDs, which may be removed. Because the tags cannot be accidentally removed, digital fingerprinting is also less error prone (more robust) than standard methods of tagging. When an object leaves a virtual vault, it may be recognized and, if it is not, an alert may be generated, or the object may be flagged for virtual digital inspection by a backend system to ascertain which object it is. This allows a system to determine when damage may have occurred and how long an object was in inventory. Identifying damage may be used in claims settlement to ascertain who bears responsibility, based on whether the object was damaged before or after it entered or exited a virtual vault. Claims settlement may be offered as a service to the warehouse owner. The system may track individual units as they are move into or out of a virtual vault.

In some implementations, sensors are made to be particularly robust and independent. For example, sensors might use solar power and communicate wirelessly; this might be as a backup where a primary and local source of power and communication channel are disrupted. Sensors may use cellular communications, such as by including an LTE SIM card. The sensors might operate entirely independent of other systems that might be present in the environment, including other sensors that are provided by the manufacturer or operator of monitoring system 106. The sensors might be configured to omit storage of data, so that they cannot be hacked or leak data. Data transmission might be secured between the sensors and onsite data compressor and sensor monitor 104 and monitoring system 106. Monitoring system 106 might include auditing systems so that all activities can be reviewed. The system can be an event-driven system so that each time a record is accessed, or each time there is an event, there is an audit trail. A land based or flying drone may periodically sweep the area to verify the integrity of the sensors and provide independent corroboration of the sensor information.

When a sensor fails or cannot use the secondary power and communication when needed, the monitoring system can issue maintenance alerts to trigger a device alert to a remote, manned service center that can provide someone to step in and repair the sensor. Some sensors might be self-restarting, reducing the need for intervention.

### Specific Example

A specific example using aspects of the present invention is described below. In this example, a designated space is defined and delineated into a space that can be considered a “virtual vault” wherein goods that are countable units are stored within the space and changes to the count of the units that exist within the virtual vault can be tracked, logged, alerted, and the like, in near real-time if needed, possibly without interaction or configuration by the operator or maintainer of the space. Examples of countable goods might be units of steel coils, boxes of foodstuffs, ingots, slabs, etc. The units might be varying both in numbers as well as in shape, from location to location and within a virtual vault. The monitoring system can be scalable with respect to sizing, quantity and reliability for use in different real-world, industrial environments.

The delineation of the virtual vault might be a three-dimensional rectangular prism of monitored space, or other shape, wherein some of the boundary of the space is only logically defined rather than being a physical boundary, such as a wall or ceiling, but might also have doors, gates, etc. that form physical boundaries. In some cases, the virtual vault can comprise physically noncontiguous spaces (zones). For example, a given location, such as a warehouse, may have two noncontiguous virtual vaults that may have their respective inventories totaled together to appear as one combined vault. In another embodiment, two or more regions in a location may be connected by a virtual vault, for example a tunnel-shaped virtual vault, allowing monitoring of the exchange of inventory between the two or more regions. Alternatively, the regions and tunnel shaped portion may all form a large virtual vault having regions connected by a tunnel shape. The virtual vault might range in size from 10 cubic meters to 200,000 cubic meters, or more or less, per storage location. The number of different types of objects in the virtual vault might vary from one to 50 different pre-defined object types to be monitored by a virtual vault, or more.

It should be understood that the example here can be extended to deal with uncountable items, such as bulk material (tonnes of iron ore, grain, etc.) and liquids and gases. Typically, the operator/maintainer of the space is not the owner of the goods, or there is another interested party (secured lender, investor, customer, etc.) that is distinct and remote from the operator/maintainer of the space and desires monitoring of the virtual vault.

The goods might be raw material inventories and the operator/maintainer might be an independent warehouse or a consignment stock facility. The monitoring system that creates the virtual vault uses a variety of on-site sensors to count, measure, and identify the goods and consequently report the status of the inventory, as well as any status changes. Some data is processed on-site and other data is processed by remote servers operated by or for, or controlled by or for, the owner or other interested party. The remote server can trigger actions and messaging to individuals or other computer systems.

In another embodiment, a bulk material such as grain may be stored in a silo.

Sensors, for example a camera or LiDAR sensor, may be mounted at various places on the silo and may measure the level of bulk material in the silo. As the silo is filled, the sensors may measure the level change in the silo, providing the amount of bulk material in the silo in real-time. The system may alternatively or additionally use a time-of-flight sensor to measure the flow of bulk material through a chute entering the silo, providing a flow rate of the bulk material. This approach provides real-time information about the level of material in the silo without having personnel visually inspect the silo, which could be potentially dangerous.

The remote servers might comprise a cloud system, a remote server farm that is managed by a monitoring system operator and provided for use by owners/interested parties. The goods might be Raw materials, commodities, inventory, or cargo. In this example, the operator/maintainer of the space is the receiver of the goods and receives them from a supplier, the party in possession of the goods that is delivering them to the space. The monitoring system might also keep track of a release schedule, which defines agreed upon dates and times and unit counts/tonnages for which movement out of the virtual vault are pre-authorized. In some cases, when the monitoring system is activated, there are already goods in the virtual vault. In such cases, there would be a starting balance, which might be provided (with any respective reference numbers, identifiers, details, etc.) to the monitoring system as the output of an audit, which might be manually performed by the operator/maintainer and/or the interested party.

Using the monitoring system, the interested party can observe and manage goods at storage locations around the world, without requiring dependence on on-site staffed services provided by other parties.

In this example, the monitoring system comprises two main components, a front-end system (FE) and a back-end system (BE). The FE comprises hardware and software at the storage location where the virtual vault is defined, including various sensors and networking and fusion of the sensors, processors for pre-processing sensor output data prior to communicating it, communications devices and configuration interface(s) for devices installed on-site. The FE also includes some cloud-based components (cloud system), such as communications devices and an extensible environment for final processing of sensor output data, such as vision and recognition processing capability, including machine learning.

In this example, the BE can reside entirely inside the cloud system managed by the monitoring system operator. The BE can host an extensible environment for data storage and application hosting, providing and ensuring integrity and authenticity of the interfaces to users.

Since the FE equipment that is deployed at a location typically owned/controlled by others, it preferably has a small physical footprint and is largely independent of the other party's infrastructure, including, where needed, being independent of the other party's electricity supply and communications channels. Of course, such equipment should be configured to comply with local legislation, such as privacy regulations and safety requirements. The on-site equipment should be reusable and removable, so that it can be added to a particular site and removed once the virtual vault is no longer needed by the interested party.

If required, the on-site equipment would comply with DIN 40050 (class 6) and ATEX directives, function from optimal light conditions to complete darkness, function in optimal weather conditions or in adverse weather such as rain, snow, wind, fog and haze, operate in a wide temperature range, function properly even when in proximity to strong electromagnetic fields, and be resilient to dust, grit and grease.

In an example, the on-site equipment will selectively record video frames deemed to represent times when movement occurs of a pre-defined set of objects passing through the boundaries of the virtual vault and capture the characteristics of the object (shape, tags and estimated volume) in digital form, and time-stamp the movement.

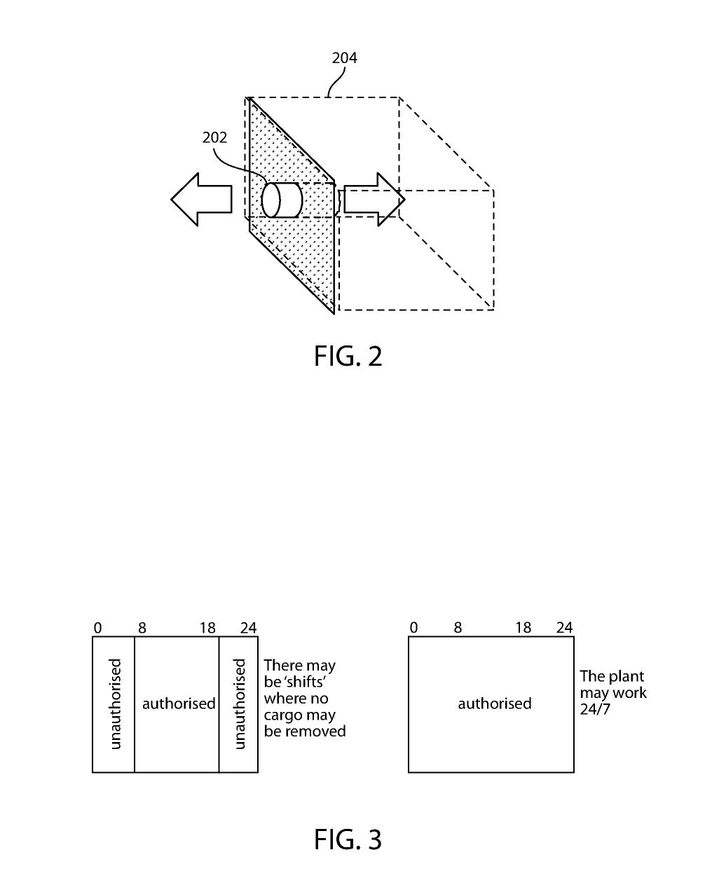

FIG. 2 illustrates an object (depicted as a cylinder 202) moving across a boundary of a virtual vault 204. The on-site equipment can process or pre-process recorded movement data to reduce the amount of data to be sent to the cloud system and send that recorded data, video frames and equipment status from the on-site equipment to the cloud system. The on-site equipment preferably secures the integrity and authenticity of the data transmission between the on-site equipment and the cloud system. The on-site equipment preferably processes the recorded movement data to accurately identify pre-defined objects crossing the virtual vault with some accuracy targets, such as less than 5% false positives and less than 5% false negatives.

The cloud system can use the received data to perform raw material object recognition and provide basis for machine learning to increase accuracy of object identification, and deliver data to the BE about recorded movements and equipment status. The BE might provide the FE with configuration data about storage locations, objects of interest and required interactions with users. The FE might be scalable to record up to 100 movements or more per hour to be monitored within the virtual vault.

As for the BE, it configures data and settings for each storage location, delivers configuration data to the FE about storage locations, objects of interest and required interactions with users. The BE also receives data from the FE about movements and equipment status, and provides for viewing and validating movements, maintains a tally of the actual amounts of predefined objects inside a virtual vault and a tally of actual weights of predefined objects inside the virtual vault, if a weighing sensor is used. The BE may use digital fingerprinting to keep a record of the location of individual objects. The BE stores video frames of movement of a pre-defined set of objects passing through the boundaries of the virtual vault, re-calculates the total weight of goods by estimating the volume of predefined objects inside a virtual vault after each recorded movement. The BE can also identify objects of interest inside a virtual vault based on available tags such as digital fingerprinting, track GPS coordinates of objects inside a virtual vault, generate reports and alerts based on predefined configuration settings, audit recorded movements, archive recorded movements, and host a user interface and secure its communication channels.

The BE can manage configuration of users, roles, credentials, access rights, storage locations (their geographical location, address, GPS coordinates, owner(s), operator(s), etc.), virtual vault data, (GPS coordinates, dimension, zones, area, etc.), objects or interest (goods) (their geometry, shape, density, surface, digital fingerprint, estimated weight, actual weight), possessor of the goods (legal name, commercial name, address, contacts, etc.), interested party or parties having an economic interest in the goods (e.g., financing party, security type, insurer, re-insurer, etc.). The BE can also manage alerts (definition of conditions which trigger alerts, types of alerts, alerts receivers, alerts' media, acknowledgment procedures, etc.), reports (definition of conditions that trigger reports, types of reports, reports receivers, etc.), and release schedules (definition of amount of objects required to be in the virtual vault at any point in time, etc.).

Reporting might include reconciliation reports highlighting the differences between the monitoring system's observations and the activities the storage location's operator indicates took place, position reports providing information on what is inside the virtual vault at a certain agreed upon point in time, and movement reports, showing time-stamped activity in to, and/or out of, the virtual vault.

The BE's archiving might provide for long term storage of system transaction data (position, movement and reconciliation reports, alerts and acknowledgements of alerts). A user interface might be provided to allow interested parties to input, modify, delete or update the various configuration data.

The monitoring service can replicate human-managed services that are industry norms for monitoring unitized commodity cargoes, such as recognizing each type and shape of commodity and know how many units are present, measure how much there is as needed, and know which units are where. This involves counting, measuring and identifying.

For counting, commodities are bought and sold as units and one of the controls is a unit count. A monitoring project may start with a manual audit to define the starting balance. Thereafter, the monitoring system counts the individual unit changes to the starting balance. Each count of a movement in or out of the virtual vault is recorded and time-stamped.

For measuring, weight can be measured using scales to weigh individual units or weight is estimated, such as by using the density configuration details. For example, the monitoring system might determine dimensions of each unit and derive the estimated weight from known densities for that commodity type. In one embodiment, the dimensions may be determined from a point cloud generated by one or more combinations of conventional cameras, infrared cameras, time-of-flight (ToF) cameras, radar detectors, and LiDAR detectors. A fill factor allows for spaces in the packaging or stacking that comprise part of the measured volume. The fill factor can be fine-tuned by comparing the estimated weight (e.g., estimated volume times density times fill factor) with the weights provided by a warehouse manager at the storage location. In one embodiment, machine learning may be used to adjust the fill factor based on comparison with previously inventoried shapes and packaging. A machine learning system may recognize certain packaging or branding infer a similar fill factor to previously inventoried packaging.

For identifying, since individual units are bought and sold, each unit may have a unique identifier (reference number) and this identifier (tag) might be adhered to the unit either as a barcode, a tag or even as a hand-written identification sprayed onto the object, as is the case with steel coils. Each unit may also be identified by a digital fingerprint or other identifying features. Identification is more than just counting, as it provides information about where in the virtual vault the unit has been, where it is stored, and where it was removed from. This helps in reconciliation of stock positions in those cases where identifiers have been hidden from view, either partially or fully.

Machine learning may be used to assist in counting, measuring, and identifying. In the case of audits, manual audits may form the training set to feed into a machine learning system to further refine the ability of the monitoring system to recognize each type and shape of commodity or recognize the number of units present. As another example, initially, a system may have a manually operated service center in which a human operator reviews each movement report and corrects misidentifications of movement or inventory. An empty forklift may be erroneously identified as moving inventory as it returns from dropping off inventory, and this error may be corrected by a human operator, providing input and training to the machine learning system. Human operators may help train the system to identify items that should be excluded from inventory, such as portions of buildings, vehicles such as forklifts, shelving or other storage fixtures, and parts of the structure of the storage facility. For example, when using a volumetric approach to computing bulk inventory, everything above the floor may initially be classified as inventory. Following this simple rule, a parked forklift may be classified erroneously as part of the inventory. The service center may provide tools for operators to correct this error and feed this error into the system for training. In another embodiment, a crowd sourcing tool may present images to many human operators to draw a consensus about what is and is not inventory. The crowd sourcing tool human operators may replace service center operators, as service center operators may be relatively skilled as opposed to crowd sourcing tool operators. In either embodiment, the input from the human operators may be entered into the machine learning system to refine its ability to distinguish inventory from non-inventory.

The monitoring system may keep track of inventory by position, storing locations of units. For bulk inventory, location and quantity may be stored. This information may be presented to a user via glasses that the user wears, for example during an audit, providing the user with an augmented reality view that presents information such as quantity or unit identification when the user is looking at a particular item in inventory, speeding the inventory process.

The interested party can use the user interface to set parameters that describe when movements out of the virtual vault can take place and how many units or how many tons can move in or out of the virtual vault. These parameters for a schedule and variations from the schedule can trigger alerts. Tonnages and units can be gross, net and minimum. The user interface can provide a geographical map view, site, section and zone view, movement view (e.g., timestamp, coil ID, size/weight, camera footage, release schedule), a position view (timestamp, GPS coordinates, # of coils, total weight, release schedule, etc.), and an event view (e.g., time stamp, event ID, event information, user action, release schedule). The information may be tracked in scheduler 114.

For validation, the monitoring system might provide position reconciliation to reconcile the position report with information provided by the warehouse, and provide functionality to manually correct the position information. Validation might also involve checking that all movements have been caught by the sensors and provide functionality to manually correct the movement information. Validation might involve updating any incomplete identification references on the units missed by the sensors and validating estimated weight and throw an alert if the difference is outside of tolerance and cannot be explained by reviewing video records. Incomplete identification and missed units may be entering into a machine learning system to help train the system to assist in future reconciliations. Repeated incomplete or missed identification of units may be flagged by the system and cause an alert, indicating that inventory is not arriving at or leaving from a virtual vault normally and may require further investigation.

The position data may be used as a report by itself. A customer may prefer to see the inventory as a snapshot of what is in a location at a given time. For example, a customer may take a snapshot at a certain time and take another snapshot 24 hours later to compare the inventory change over a 24 hour period. This may be done in an area that is not a virtual vault. This allows a customer to set up a simplified ad hoc area to be inventoried with reduced set up effort. In one embodiment, the monitoring system may provide a real time inventory which is instantly available and serves as a check on an enterprise resource planning (ERP) system which calculates inventory based on other inputs. The monitoring system and the ERP system function as a double check and audit for each other. The monitoring system reports may be provided through a simpler portal which is independent of the ERP system, allowing users to access inventory reports using a device such as a PC, tablet, or mobile phone. Large companies may have complicated ERP systems restricted by proprietary information technology systems. Delivering inventory reports in a simpler interface may satisfy employees who demand constant inventory data.

When an unauthorized movement of goods occurs (either outside authorized times and/or more quantity than approved) the monitoring system can generate an alert. The alert might explain the reason for it being generated. This may involve sending the alert by email, SMS or even personally contacting a customer's predefined contact person.

A customer might specify a release schedule defining allowed movements of goods in and out of the virtual vault with their commercial counterparties. Those agreements would be entered into the monitoring system database so that the monitoring system can determine which movements are authorized and which are not.

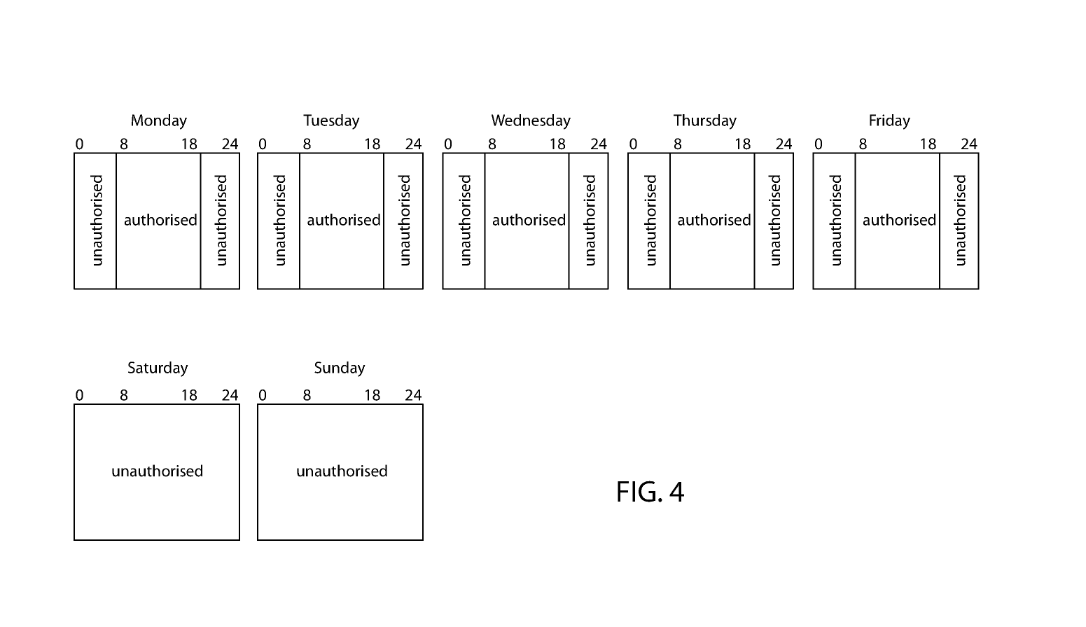

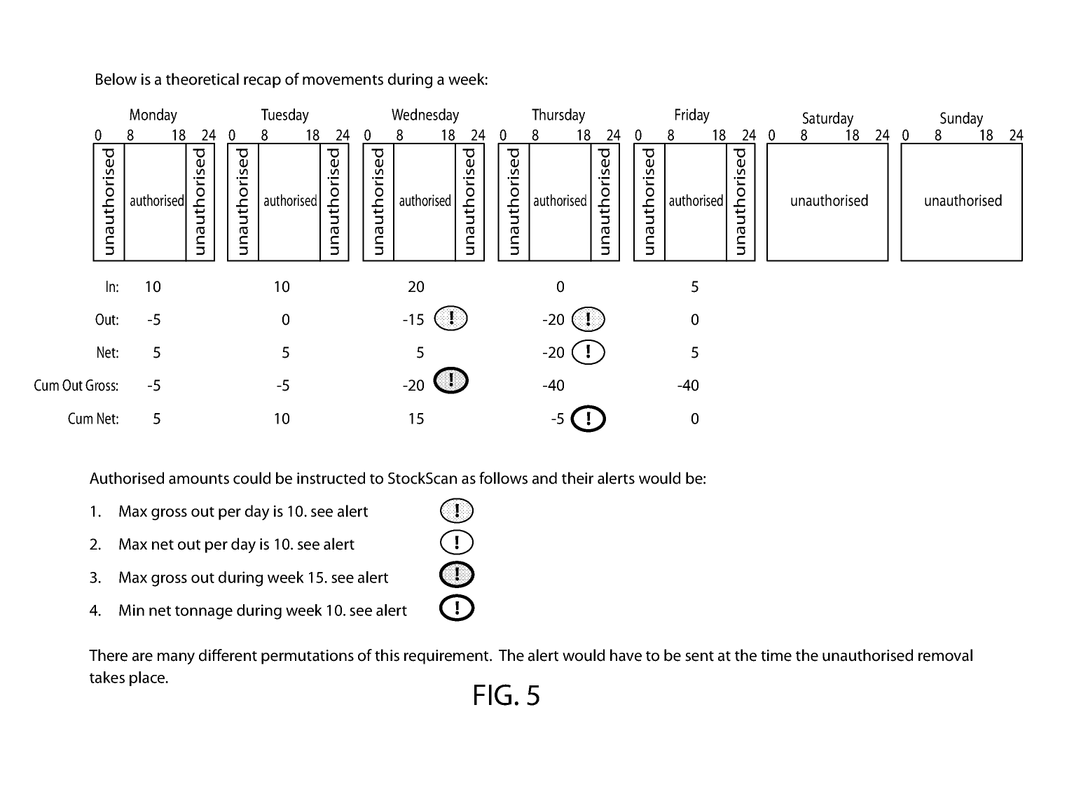

In one embodiment, a release schedule has two principal components, the authorized time period and the tonnage. For the authorized time period, a scheduler might allow for a calendar interface for users to specify the time periods. Each time period might have a start time and an end time and the time periods might be repeating. An example of a set of time periods is shown in FIG. 3. A hypothetical example could be for a week as shown in FIG. 4.

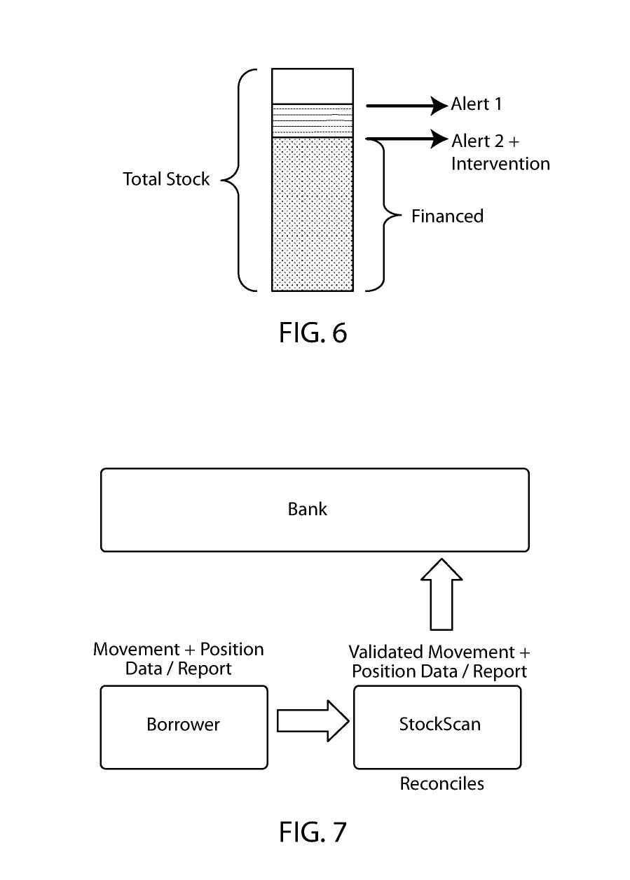

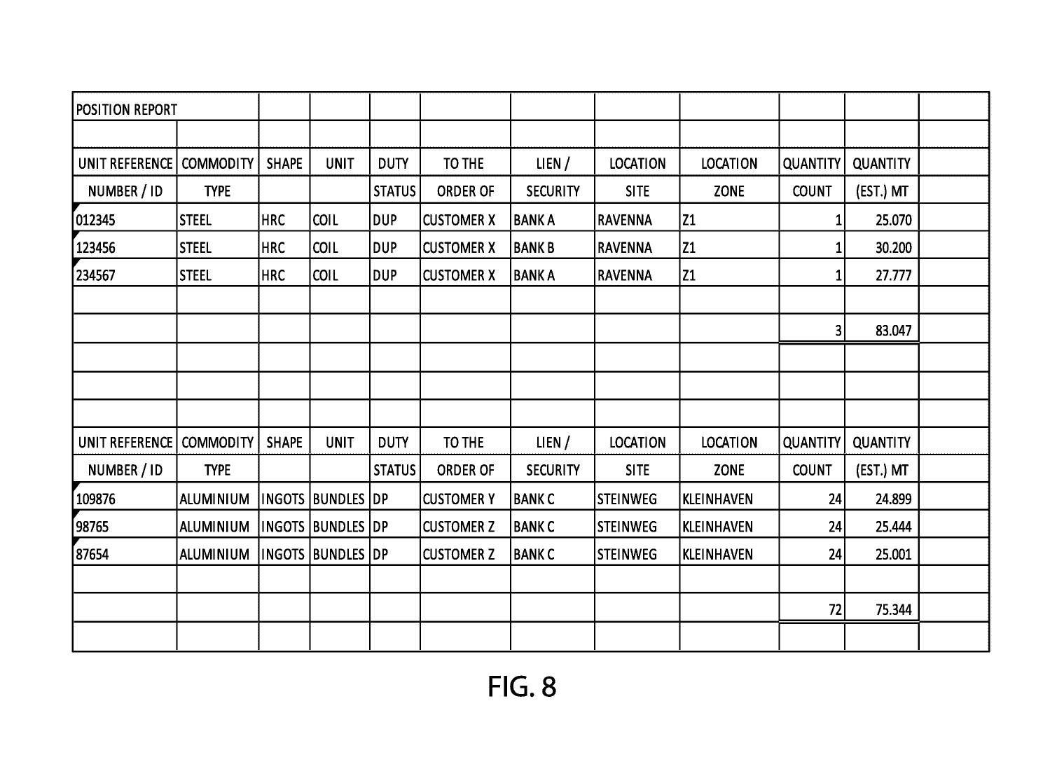

For the tonnage authorized to enter and (more importantly) to leave a monitored area, that tonnage is linked to a time component. It may be as simple as a rule that there is always a minimum tonnage (or number of units if tonnage is unavailable) in the virtual vault at any point in time. Complexity comes with scheduled movements, agreed in advance, which are either based on a net turnover or on the gross amount leaving. This complexity can be demonstrated as in FIG. 5. A simpler solution of a minimum permissible tonnage can have added complexity in that alerts might be desired as the minimum limit is approached, as illustrated by the graphic of FIG. 6.

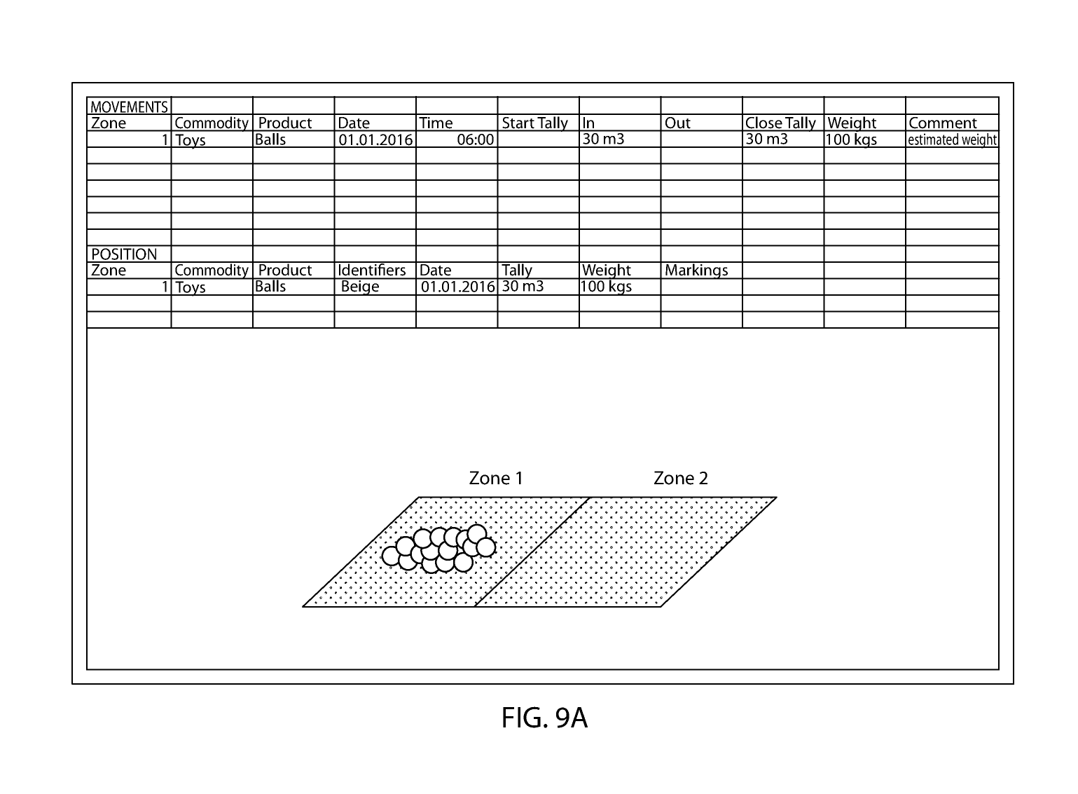

FIG. 7 illustrates a reconciliation process, whereby an interested party, such as a secured lender obtains a validated report from the monitoring system operator reconciled against a report provided by the borrower.

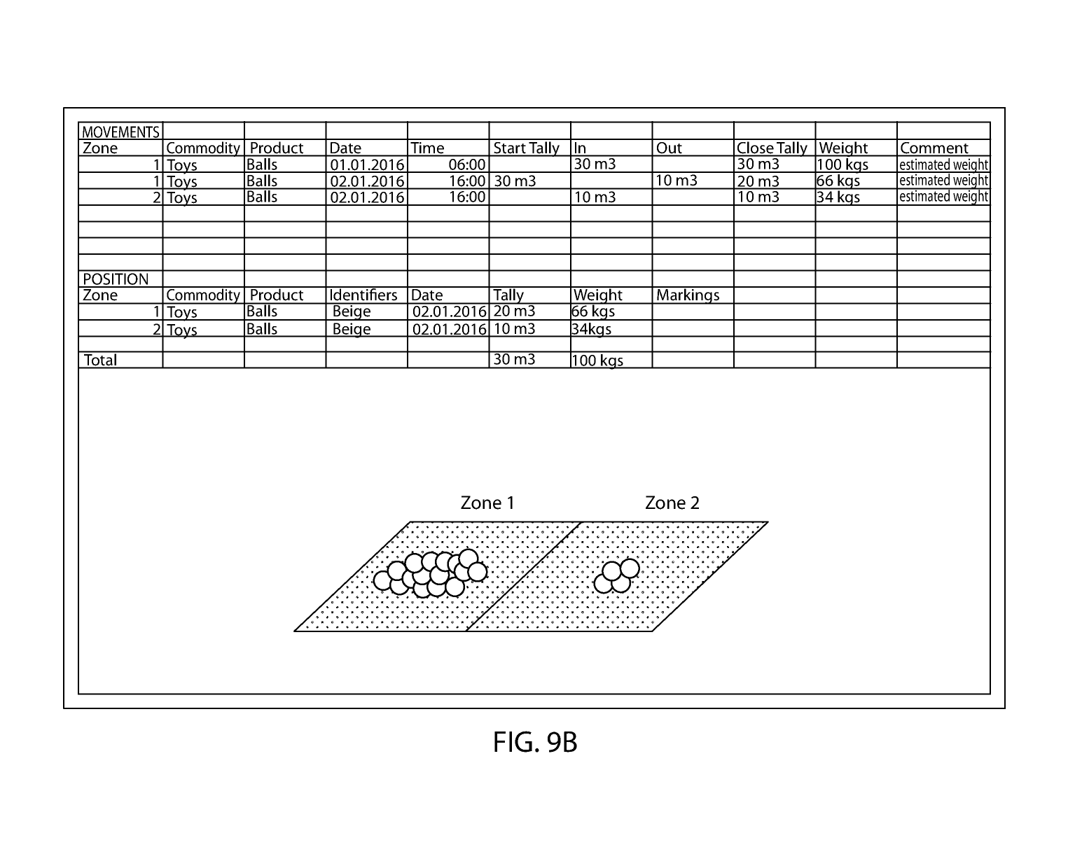

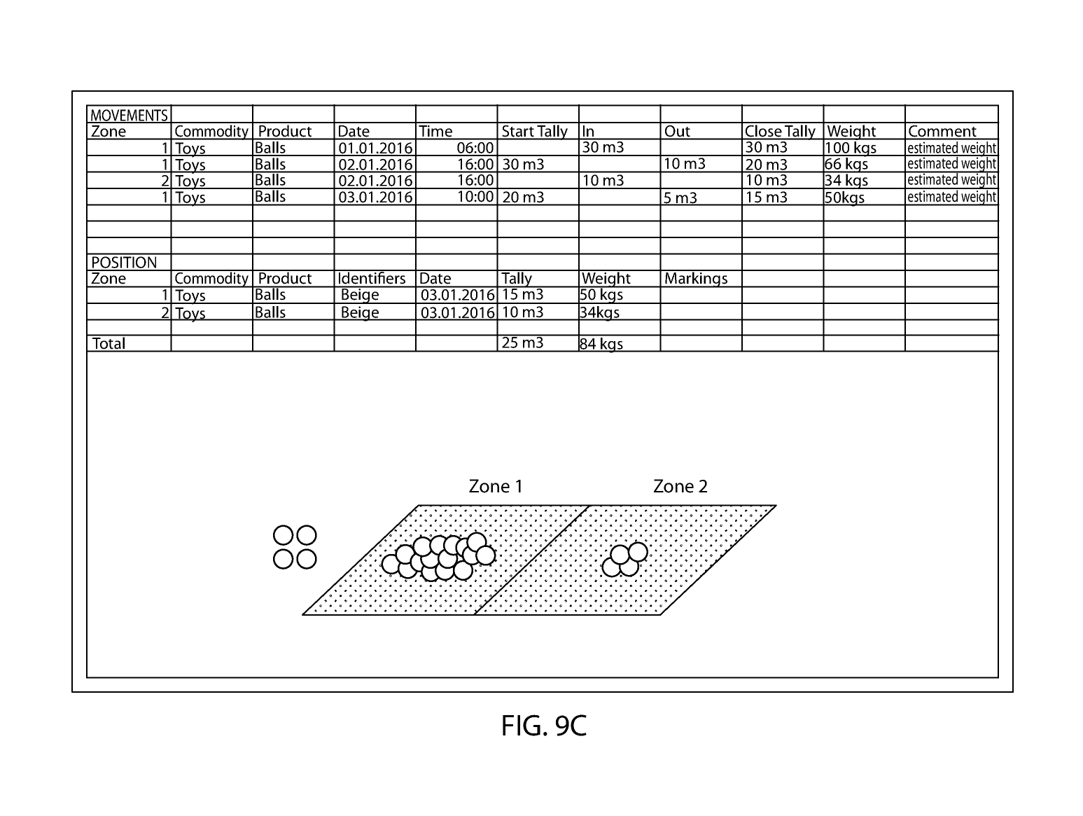

FIG. 8 illustrates an example movement report that identifies when items entered and left the position report for a predefined period. FIGS. 9A-9C illustrate three snapshots in a sequence. In FIG. 9A, the first snapshot, all of the items are in zone 1. In FIG. 9B, the second snapshot, some of the items moved from zone 1 to zone 2. In FIG. 9C, the third snapshot, some of the items are removed from the inventory and are in neither zone. In the upper portion of the display for each of these sequences, the data is provided in tabular form, listing movements and the current positions. In the lower portion of the display for each of these sequences, the data is depicted graphically.

In the examples above, countable goods are described. These are things such as unitized stock that are normally identified by a code or marking, such as steel coils, aluminum ingots, or iron slabs. These examples could be expanded to cover bulk stock, such as loose cargoes stored in stockpiles, silos and bunkers where identifying each individual unit is not required (e.g., coal, grain), and/or liquids and gases stored in tanks with volumes normally measured by flow meters (e.g., diesel fuel).

According to one embodiment, the techniques described herein are implemented by one or generalized computing systems programmed to perform the techniques pursuant to program instructions in firmware, memory, other storage, or a combination upon communication with one or more sensors as described above to assess and track inventory. Special-purpose computing devices may be used, such as desktop computer systems, portable computer systems, handheld devices, networking devices or any other device that incorporates hard-wired and/or program logic to implement the techniques.

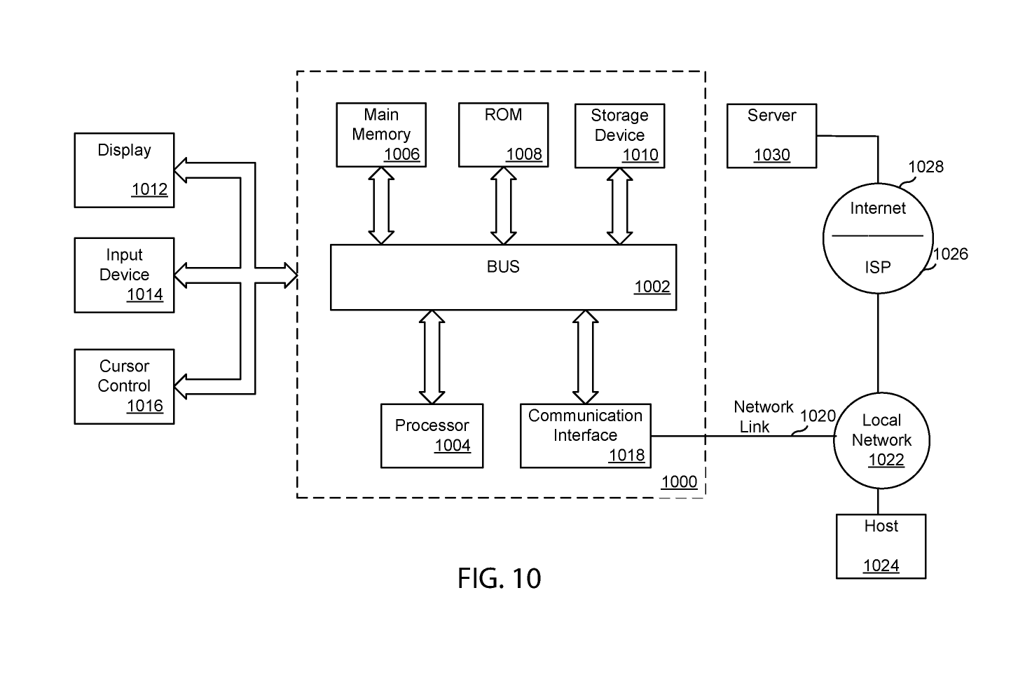

For example, FIG. 10 is a block diagram that illustrates a computer system 1000 upon which an embodiment of the invention may be implemented. Computer system 1000 includes a bus 1002 or other communication mechanism for communicating information, and a processor 1004 coupled with bus 1002 for processing information. Processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a computer monitor, for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a network connection. A modem or network interface local to computer system 1000 can receive the data. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, a system component based on the global system for mobile communication (GSM) protocol, cable modem, satellite modem, or a modem to provide a data communication connection to a corresponding type of telephone line. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage device 1010, or other non-volatile storage for later execution.

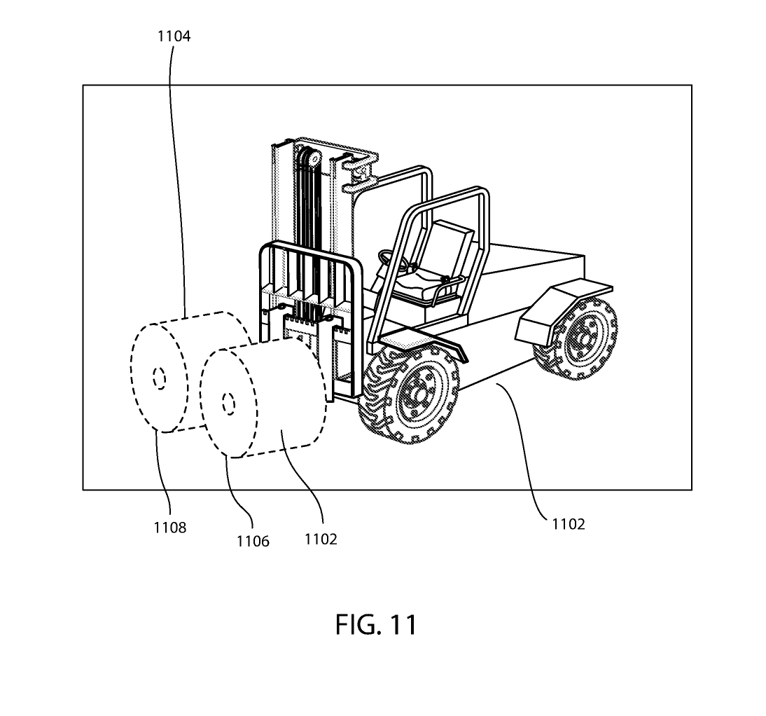

FIG. 11 illustrates a vehicle (e.g., a forklift) 1102 moving two spools 1102, 1104 of aluminum. Outlines 1106, 1108 represent the volume of the cylinders, which would be identified by a point cloud.

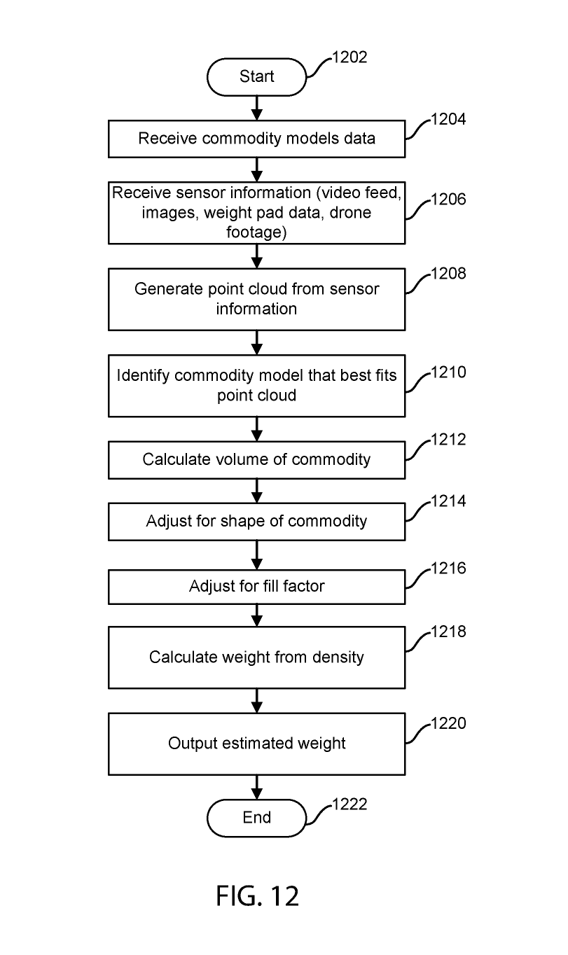

FIG. 12 is a flowchart of a process of calculating the weight of an inventory item from sensor data. The process starts at step 1202. In step 1204, the backend system receives model data describing the shape of a commodity. In step 1206, the backend system receives sensor information, which may include traditional video or still photo camera data (e.g., RGB camera data), infrared camera data, and time of flight camera data. The sensor information may also include radar or LiDAR data. In step 1208, the backend system generates point cloud information from the sensor data. In step 1210, the backend system identifies which commodity model best matches the point cloud information. In step 1212, the backend system calculates the volume of the commodity. In step 1214, the backend system adjusts the volume for the shape of the commodity.

For example, for a roll of aluminum, there will be a gap between layers as well as a hollow center, such that the roll of aluminum cannot be treated as a solid cylinder of aluminum. In step 1216, the adjusted volume of the commodity is further adjusted for a fill factor. For example, in the case of steel drums of a fluid, the drum may only be 98% full, requiring the volume of the drum to be multiplied by 0.98 to derive the actual volume of the contents of the drum. In step 1218, the mass or weight of the commodity is calculated from the density of the commodity. The density may be supplied with the model data or may be available from publicly available sources. In step 1220, the weight is output to, for example, an inventory database of the backend system or other part of the monitoring system. The output may be a delta which is used to increment or decrement the amount of inventory in a virtual vault or other region. In step 1222, the process ends.

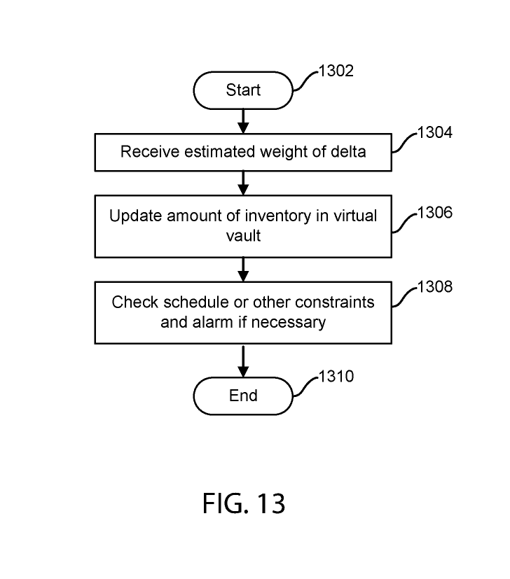

FIG. 13 is a flowchart of a process of tracking inventory within a virtual vault or other region (e.g., a warehouse) using deltas, or changes due to items entering and leaving the virtual vault. In step 1302, the process starts. In step 1304, the backend system receives an estimated weight of a delta, which is the weight or mass of material to be added or subtracted from the inventory in a region. In step 1306, the backend system updates the inventory in the virtual vault or other region to account for the delta entering or exiting. In step 1308, the backend system compares the delta to a schedule. If the delta is outside of a scheduled movement of inventory or above or below weight or other parameters, the backend system may generate an alarm or other alert. In step 1310, the process ends.

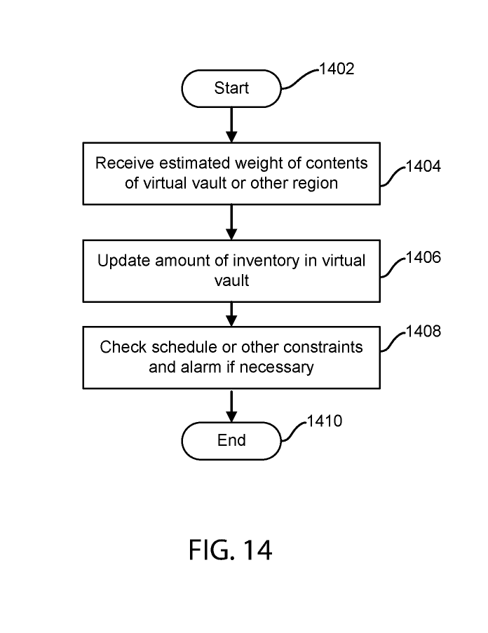

FIG. 14 is a flowchart of a process of tracking inventory within a virtual vault or other region (e.g., a warehouse) based on sensor data from within the virtual vault. In step 1402, the process starts. In step 1404, the backend system receives an estimated weight of the contents of the virtual vault, which is the weight or mass of material within the inventory in a region. In step 1406, the backend system updates the inventory in the virtual vault or other region. In step 1408, the backend system compares the inventory to a schedule. If the inventory is above or below the weight or other parameters anticipated for the inventory based on the schedule, the backend system may generate an alarm or other alert. In step 1410, the process ends.

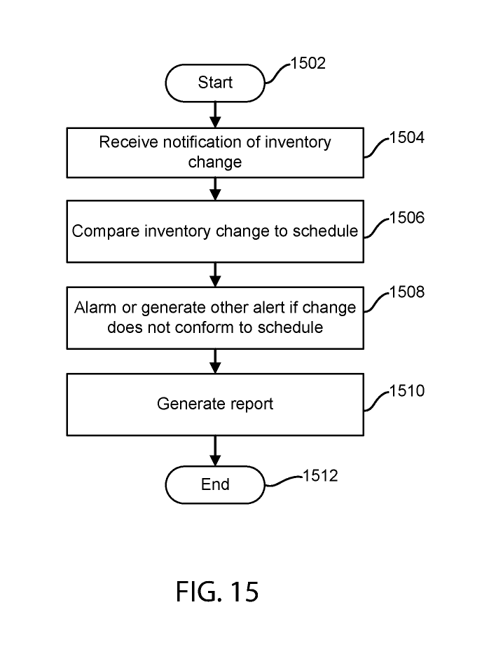

FIG. 15 is a flowchart of a process for verifying inventory movements conform to a schedule and alarming if the schedule is violated. The process starts at step 1502. In step 1504, the backend system receives notification that an inventory has changed, either from a delta process or from a comparison of a current inventory to a previous inventory. In step 1506, the inventory change is compared to the schedule from the scheduler component. In step 1508, an alarm or other alert is generated if the inventory change does not conform to the schedule. In 1510, a report of the inventory change is generated and saved in the backend system. In 1512, the process ends.

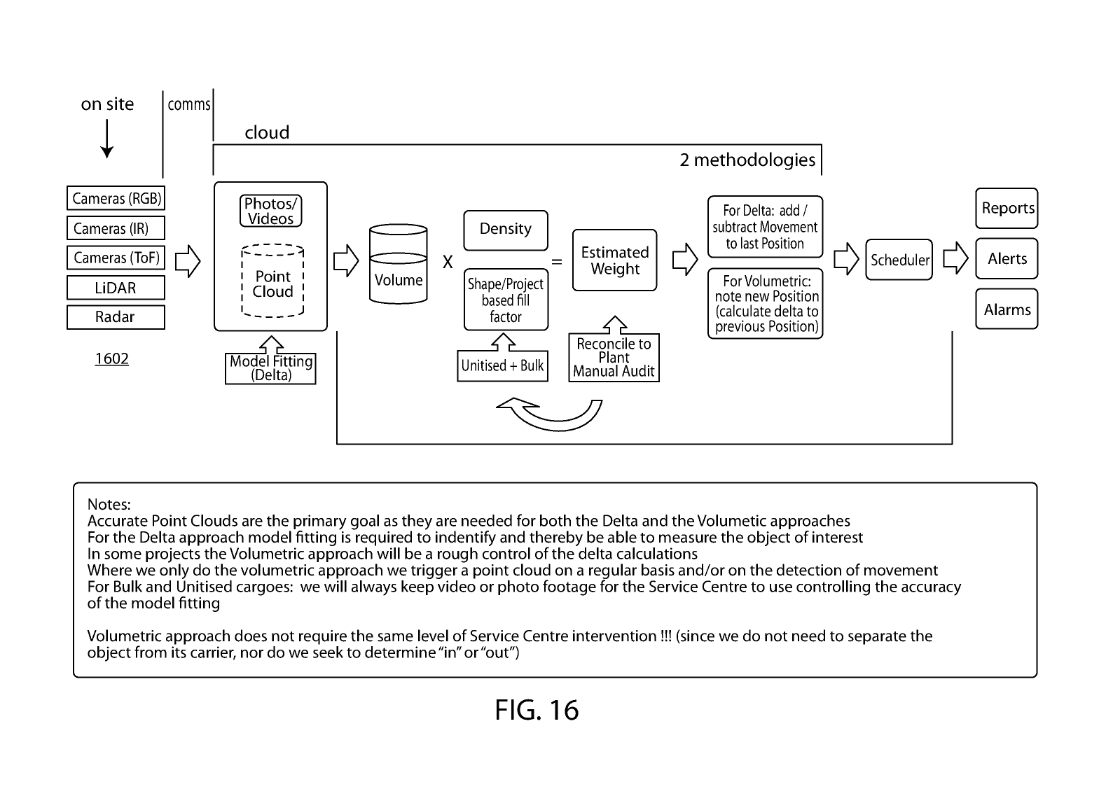

FIG. 16 illustrates an end to end flow of data through the system. A sensor array 1602 on site captures image, range data including positioning points, and other data. The sensor array may include other sensors such as weight sensors. The sensor data is communicated by a communication system, for example LTE cellular technology, to a monitoring system, which includes a point cloud fitting system. The sensor data may be compressed on-site by a compression system. The point cloud fitting system of the monitoring system receives the photos, videos, and other data from the sensors. The point cloud fitting system also receives, or may already have been provided with, model fitting data which describes the commodity shape and size to be inventoried. A model is fit to the point cloud to calculate a preliminary volume. Depending on the type of commodity, the volume may be adjusted by a density of the commodity, for example unitized commodities such as metal ingots or billets may have their weight calculated by multiplying the volume of the shape of the ingot or billet by a density. The density may be based on the model or may come from other sources. Bulk commodities or commodities which come in a container, for example a liquid or gas, may have the volume adjusted by a shape or project based fill factor. For example certain containers from a particular distributor may be filled to 95% by contract. Applying the density of fill factor yields an estimated weight.

The estimated weight may be used as an input to either a delta process (see FIG. 13) or a volumetric inventory process (see FIG. 14). If the estimated weight is part of a delta process, the inventory is added to or subtracted from the inventory in a virtual vault or other region to calculate the contents of the virtual vault or other region. The estimated weight, calculated from the volume in a region, may also be representative of the contents of a virtual vault or other region.

In either case, after the estimated weight is used to update the inventory of a region, the inventory and inventory change may be checked in a scheduler and an inventory report generated. An alert may also be generated. If the inventory does not match the scheduled inventory, within some parameters, an alarm or other alert may be generated.

Accurate point clouds make the delta or volumetric inventory monitoring more efficient. Model fitting is helpful to the delta approach to identify objects of interest as they enter and exit a virtual vault. For example, a forklift carrying rolls of commodity out of a virtual vault may be identified. Rather than have the entire forklift identified as commodity, the monitoring system recognizes the forklift and the commodity rolls and excludes the forklift from the point cloud, keeping only the commodity rolls.

In a volumetric inventory based system, identifying the commodity and excluding building structures, parked vehicles, and other non-commodity objects from the point cloud makes the inventory more accurate. Generally, the volumetric approach will not require the inventory object to be separated from an object carrying it, requiring less training of the model or correction by a human operator.

In some embodiments, an update to the inventory, either volumetric or delta based, may be caused by movement, for example, above a certain threshold. In other embodiments, a scan may be periodically executed. Multiple camera angles may be used to construct the point cloud, and objects that move may be identified as either commodity or objects such as vehicles or people that are not to be inventoried. In some embodiments, only a portion of a region may be scanned, for example only one camera angle, with the shape of, for example a pile of commodity, inferred from the partial scan. For bulk or unitized cargo, video or photo footage may be retained to aid in training the model to recognize objects of interest.

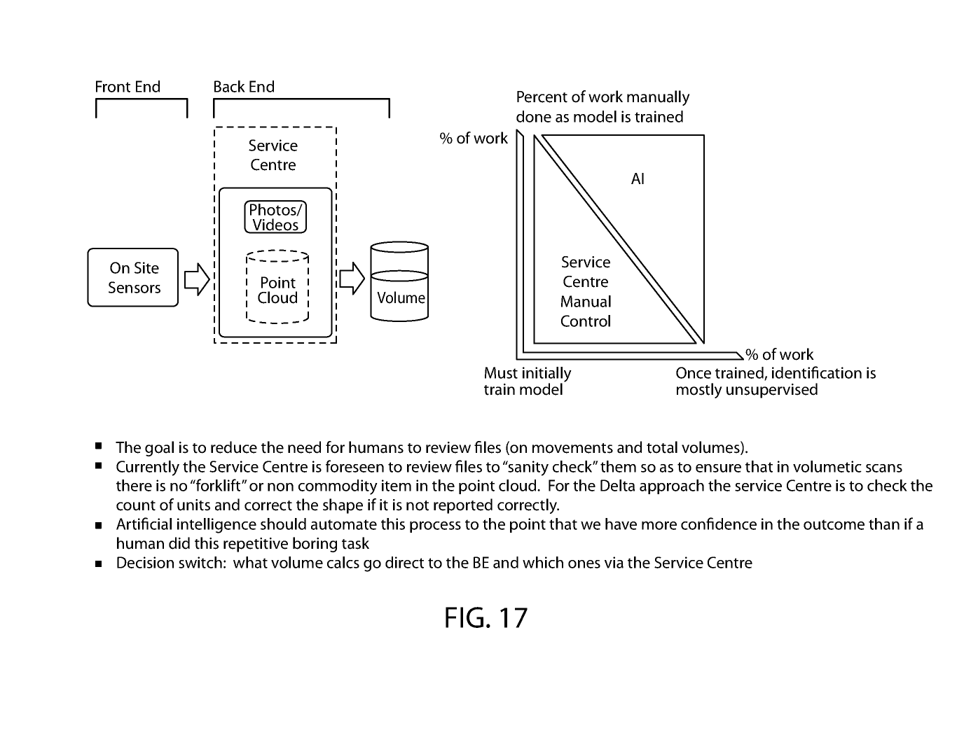

FIG. 17 focuses on the service center which is part of the backend system. The service center may contain the portions of the system which receive the photos, videos, or other sensor data. The service center may also contain the servers which generate a point cloud from the sensor data and fit a model to the point cloud in order to generate a volume. When the system is initially placed in service, it may have a model that is mostly or partially untrained, requiring more frequent human operator intervention than a trained model. The human operators may sanity check the models volumetric scans, for example to exclude forklifts from a commodity being moved or eliminate parked vehicles from a volumetric scan. The corrections from the human operators may be used to further train and refine the model. As the model becomes more sophisticate, human intervention should decrease over time, as show in the graph in FIG. 17. At some point, the monitoring system may be accurate enough for some or all volume and delta calculations to go the backend and be reflected in inventory of virtual vaults or other regions without human intervention in the service center.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A computer system for monitoring physical commodities based on sensor data about those physical commodities, monitoring comprising at least detecting changes in their quantities and/or their properties, the computer system comprising:
a plurality of sensors, spatially positioned to cover a predefined delineated space containing an inventory of the physical commodities;
a processor, coupled to receive signals from the plurality of sensors;
a memory, coupled to the processor, that provides storage for the sensor data; and
program code, executable by the processor and stored in nontransitory computer readable media, comprising:
a) program code for calculating a plurality of physical properties of the inventory;
b) program code for determining one or more boundaries of the predefined delineated space;
c) program code for mapping changes in the sensor data to changes in the physical properties of the inventory; and
d) program code for determining a response to changes in an inventory that are based on the changes in the physical properties of the inventory.

2. The computer system of claim 1, further comprising:
a plurality of servers capable of communicating with the processor over a network, thereby providing resilience against errors and an independent path from the plurality of sensors to the processor;
program code for recording objects of interest passing through the boundaries of a predefined delineated space;
program code for issuing alarms based on a further analysis of determined changes to an inventory level;
a storage device for archiving services, transactions occurring with respect to the boundaries, and data related to object recognition and machine learning; and
program code, executable by one or more of the plurality of servers, for analyzing archived data to derive historical data used by the program code for determining a response to provide improved responses.

3. The computer system of claim 2, wherein the processor is integrated with the plurality of servers.

4. The computer system of claim 2, further comprising one or more personal computer, smart phone, and facsimile machine for receiving reports or presenting data collected by the plurality of servers.

5. The computer system of claim 2, further comprising mechanisms to ensure confidentiality, integrity, and availability, of system components, comprising at least:
a plurality of cryptographic processors that use digital signatures, message authentication codes, encryption, and standard Internet security protocols;
program code for implementing heartbeat messages, timestamps, and counters; and
program code for access control to restrict access to sensor data, logs, and other collected or processed data on the processor and the plurality of servers.

6. The computer system of claim 1, wherein the plurality of sensors comprise optical devices, cameras, light detectors, lasers, depth sensors, motion sensors, radar, weight sensors, pressure sensors, and/or ultrasonic emitters.

7. The computer system of claim 1, wherein the plurality of physical properties of the inventory comprises volume, shape, weight, material, number of units, and/or density.

8. The computer system of claim 1, wherein the boundary of the predefined delineated space corresponds to a building interior, a silo, a bunker, a tank, or a bounded outdoor space.

9. The computer system of claim 1, wherein the response to changes in an inventory level include one or more of generating a report, sending a notification to one or more servers, and/or storing associated data.

10. The computer system of claim 1, further comprising program code for combining data from a plurality of distinct sensor types and determining changes of the sensor data over time, thereby providing for recognition of untagged commodity objects and data about movements and positions of the untagged commodity objects.

11. The computer system of claim 1, wherein the sensor data comprises two-dimensional video images of the physical commodities, from a plurality of cameras.

12. The computer system of claim 11, wherein changes of volume or number of the physical commodities is determined by performing computations on the two-dimensional video images.

13. The computer system of claim 12, wherein the computations include inputs related to sensor data from nonimage sensors.

14. The computer system of claim 13, wherein the nonimage sensors are sensors for weight, shape, sound, and/or material.

15. The computer system of claim 11, further comprising program code to compute, from the two-dimensional video images, three-dimensional representations of the physical commodities and variations of volume of the physical commodities.

16. The computer system of claim 15, wherein the program code to compute the three-dimensional representations uses, as an input, prior recorded knowledge about a three-dimensional geometry and/or material of the physical commodities.

17. The computer system of claim 16, wherein the prior recorded knowledge comprises a measurement of a characteristic signature function of material of the physical commodity with respect to the sensor.

18. The computer system of claim 17, wherein the sensor is configured to provide data to differentiate from characteristics of a material.

19. The computer system of claim 18, wherein the material has a known surface structure and light reflection characteristic corresponding to a predefined chemical element or composite that can be monitored.

20. The computer system of claim 1, further comprising program code for limiting sensor data to data collected for inside the predefined delineated space and correcting for certain sensor data that corresponds to outside the predefined delineated space.

21. The computer system of claim 20, further comprising a plurality of laser emitters and a plurality of laser detectors, using visible and/or infrared light to monitor physical commodities entering or exiting the predefined delineated space.

22. The computer system of claim 1, wherein the change of the sensor data is computed by a probabilistic measure to determine reliability of the detection.

23. The computer system of claim 22, wherein a decision process comprises a first stage of a conservative decision computational process and a second stage of a secondary, more informed process of computing a confidence measure to determine a decision quality.

24. The computer system of claim 1, wherein human observer inputs as to changes in the physical commodities are used in a machine learning process, whereby differences between inventory levels based on the human observer inputs and inventory levels based on sensor data computation provides training data for the machine learning process.

25. The computer system of claim 1, further comprising program code for distinguishing an individual inventory item from a plurality of inventory items based on surface features of the individual inventory item and surface features of each of the plurality of inventory items.
